(19) United States
(12) Patent Application Publication
(10) Pub. No.: US 2016/0261302 A1
(43) Pub. Date: Sep. 8, 2016

(54) METALLIC CASE FOR PORTABLE PHONE FORMED THROUGH PRESS PROCESS AND METHOD OF MANUFACTURING THE SAME

(71) Applicant: ST Corporation Co., Ltd, Chilgok-gun (KR)

(72) Inventor: Byeongdu AN, Changwon-si (KR)

(21) Appl. No.: 15/061,162

(22) Filed: Mar. 4, 2016

(30) Foreign Application Priority Data
Mar. 6, 2015 (KR) 10-2015-0031953
Mar. 7, 2015 (KR) 10-2015-0063556
May 13, 2015 (KR) 10-2015-0066870
Aug. 26, 2015 (KR) 10-2015-0120362

(51) Int. Cl. H04B 1/3888

(52) U.S. Cl. CPC H04B 1/3888

(57) ABSTRACT

A metallic case for a portable phone is mounted thereon with a display part and a backlight part of the portable phone. A press process is performed with respect to a metallic plate including a carbon steel, stainless steel, aluminum, and the alloy thereof to integrally form an inner space in one surface or both surfaces of an inner wall surface, so that a screen part including a window glass, and a board part and a battery to drive the screen part are mounted in the inner space, thereby significantly reducing the number of processes, increasing the whole strength, maximizing thermal diffusion, facilitating the mounting of the window glass located on the front surface of the metallic case and the mounting of the battery cover located on the rear surface of the metallic case, and allowing the mounting without clearance.

### CROSS-REFERENCE TO RELATED APPLICATION(S)

This application claims the benefit under 35 U.S.C. §119(a) of a Korean patent application filed on Mar. 6, 2015 in the Korean Intellectual Property Office and assigned Serial number 10-2015-0031953, of a Korean patent application filed on Mar. 7, 2015 in the Korean Intellectual Property Office and assigned Serial number 10-2015-0063556, of a Korean patent application filed on May 13, 2015 in the Korean Intellectual Property Office and assigned Serial number 10-2015-0066870, and of a Korean patent application filed on Aug. 26, 2015 in the Korean Intellectual Property Office and assigned Serial number 10-2015-0120362, the entire disclosure of each of which is hereby incorporated by reference.

### TECHNICAL FILED

The present invention relates to a metallic case for a portable phone, which is mounted thereon with a display part and a backlight part of the portable phone, and more particularly to a metallic case for a portable phone, in which a press process is performed with respect to a metallic plate including a carbon steel, stainless steel, aluminum, and the alloy thereof to integrally form an inner space in one surface or both surfaces of an inner wall surface, so that a screen part including a window glass, and a board part and a battery to drive the screen part are mounted in the inner space, thereby significantly reducing the number of processes, increasing the whole strength, maximizing thermal diffusion, facilitating the mounting of the window glass located on the front surface of the metallic case and the mounting of the battery cover located on the rear surface of the metallic case, and allowing the mounting without clearance.

### BACKGROUND

In general, a portable phone (including a smart phone) essentially requires a case having an inner space to mount various electronic components (including a battery) therein or to fix an external liquid crystal used to display information. The various electronic components and the battery may be mounted on one surface or both surface of an inner wall surface by edge walls formed perpendicularly to the inner wall surface of the case.

In generally, the edge walls perpendicular to the inner wall surface are formed through an injection-molding process for plastic. The plastic does not provide an excellent grip feeling for a user and is weak in impact.

However, in order to overcome the above problem while improving durability against external shock, the use of a case formed of metal is increased.

A metallic case, which has been recently used, is manufactured in the shape of a typical rectangular frame through a die-casting process for an aluminum alloy. In this case, a flow hole formed in the die-casting process must be cut, and burrs may be not clearly removed in the process of removing the burrs after blanking and post processes, thereby causing defects. The case manufactured through such die-casting may be deformed in other subsequent processes such as a plating or painting process which is additionally formed.

Accordingly, in order to solve the above problem, a manner of forming an outer portion of the case through the die-casting process, and forming an inner portion of the case through an insert-molding process using plastic has been mainly used. When the case is formed of metal through the above manner, the manufacturing processes are complicated, and the inner portion of the case is filled with plastic resin, so that heat may not be smoothly dissipated outside, and the production process is very complex.

As prior arts, there are Korean Utility Model Registration No. 20-0470996 (patent document 1) and Korean Patent Registration NO. 10-1443565 (patent document 2).

### SUMMARY OF THE INVENTION

The present invention is to facilitate the mounting of a window glass or a battery cover located at the front of various electronic components and a battery mounted in an inner space not only by realizing an edge wall forming the inner space with one surface or both surfaces of an inner wall surface formed only through a press process using one metallic plate, but also by forming the thickness of the edge wall thicker than that of the inner wall surface formed through the press process for the metallic plate.

In addition, the present invention is to prevent impact from being transferred to electronic components mounted on an inner wall surface even if strong impact is applied to an edge wall.

To this end, a metallic plate is subject to a plastic process to be in a rectangular frame including an edge wall so that an inner space is formed in one surface or both surfaces of an inner wall surface through a drawing process by a press. In this case, the edge wall is realized in the rectangular frame having curved corners, having a uniform thickness, and having no wrinkle, fracture, and joint.

Further, in order to overcome the limitation in the thickness of the edge wall, the edge wall is formed with a thickness thicker than that of the inner wall surface due to the malleability of the workpiece in the drawing process by the press, or a folding surface is formed to be overlapped with the edge wall by bending the edge wall, so that the width of the upper end of the edge wall is increased at one side or both sides of the edge wall.

In addition, due to the increased width of the upper end of the edge wall at the one side or both sides of the edge wall, a step surface is easily formed through an NC process to mount a window glass or a battery cover, or formed through a bending process by the press without performing the NC process, so that the manufacturing process is easily performed.

As described above, the edge wall can be formed to form the inner space in one side or both sides of the inner wall surface through the press process for the metallic plate. The edge wall can be formed with the thickness thicker than that of the inner wall surface through the press process due to the malleability of the metallic plate, or through the folding process resulting from the bending of the edge wall. Accordingly, the impact resistance of the edge wall can be improved and the forming of the mounting surface can be easily performed for the mounting of the window glass and the battery cover on the upper portion and the lower portion of the edge wall.

In addition, the manufacturing process of such a product can be simplified through the press process, so that the manufacturing cost can be reduced. Further, due to the characteristic of metal, heat can be dissipated, and the outer surface of the edge wall can be additionally processed, so that the grip feeling of the user can be variously improved.

### BRIEF DESCRIPTION OF THE DRAWINGS

FIG. 1 is a perspective view showing an outer appearance of a metallic case according to the first embodiment of the present invention.

FIG. 2 shows the assembly of the metallic case with a typical window glass and a typical cover according to the first embodiment of the present invention.

FIGS. 3 to 8 are views showing the manufacturing process according to the first embodiment of the present invention.

FIG. 9 is a view showing another example of forming a folding surface according to the first embodiment of the present invention.

FIG. 10 is a view showing a third example of forming a step surface according to the first embodiment of the present invention.

FIG. 11 is a view showing an example of forming a cut-out portion when a support surface is processed according to the first embodiment of the present invention.

FIG. 12 is a process chart showing the first embodiment of the present invention.

FIG. 13 is a view showing an example of forming a metallic case according to the second embodiment of the present invention.

FIGS. 14 to 17 are views showing the manufacturing process according to the second embodiment of the present invention.

FIG. 18 is a process chart showing the manufacturing process according to the second embodiment of the present invention.

FIG. 19 is a view showing an example of forming a metallic case according to the third embodiment of the present invention.

FIGS. 20 to 27 are views showing the manufacturing process according to the third embodiment of the present invention.

FIG. 28 is a view showing another example of forming the metallic case according to the third embodiment of the present invention.

FIGS. 29 to 35 are view showing the manufacturing process according to the third embodiment of the present invention.

FIG. 36 is a sectional view showing the metallic case according to the third embodiment of the present invention.

### DETAILED DESCRIPTION OF THE INVENTION

Hereinafter, the present invention will be described in detail with reference to accompanying drawings.

A metallic case for a portable phone according to the present invention is formed by using a metallic plate having excellent heat dissipation, excellent corrosion, toughness, and malleability. As the metallic plate is press-processed, the metallic case for the portable phone has an edge wall having a predetermined height perpendicularly to an edge of an inner wall surface, has an inner space formed in one surface or both surfaces of the inner wall surface to mount electronic components therein, has each corner part to maintain the metallic case in a uniform state without wrinkles or fractures, and facilitate the mounting of a window glass or a cover.

To this end, the metallic case for the portable phone according to the first embodiment of the present invention may be used for a built-in battery type, and metallic cases for a portable phone according to the second and third embodiments may be used for an external battery type.

Hereinafter, one embodiment will be described in detail.

According to the first embodiment of the present invention used for the built-in battery type, an inner space 13a is formed only in one surface of an inner wall surface 11. In detail, the inner wall surface 11 for the mounting of electronic components and a window glass 40 at one side thereof, and an edge wall 14 perpendicular to the inner wall surface 11 are formed to provide the inner space 13a by performing a press process with respect to one sheet of a metallic flat plate. An insertion groove 19 may be formed in an opposite surface of the inner wall surface 11 through an NC process. A step surface 17 is provided at an upper end of the edge wall 14 through an NC process, so that the window glass 40 may be mounted in the state that the electronic components are mounted in the inner space 13a, and a cover 50 may be mounted into the insertion groove 19 in the opposite surface of the inner wall surface if necessary.

In this case, when the NC process is performed, an outer surface 14a of the edge wall 14, which is exposed, is processed in the form of a curved surface in order to improve a grip feeling, or divided into equal parts and formed in a chamfered surface so that the outer surface 14a is inclined at a predetermined angle inward at an upper side, a lower side, or both lateral sides of the edge wall. Accordingly, the outer surface 14a may be provided in various shapes. The forming of the outer surface 14a has been described according to one embodiment only for the illustrative purpose, and the present invention is not limited thereto.

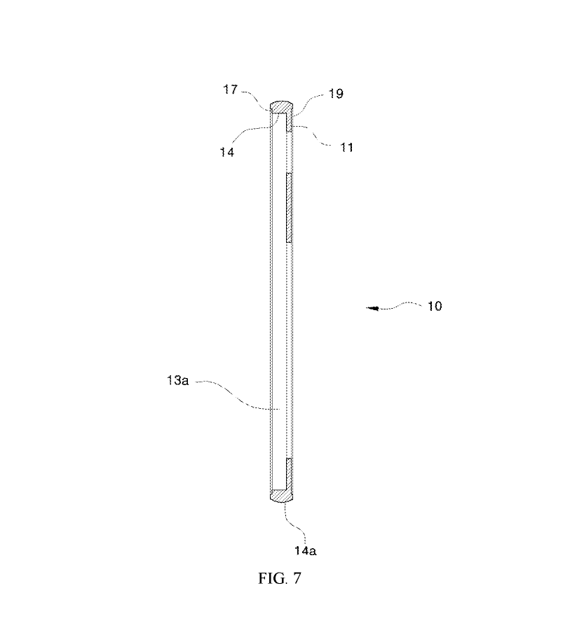

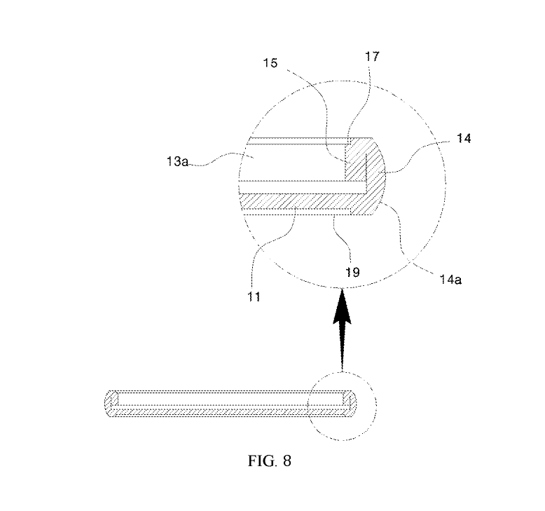

Further, the inner wall surface 11 and edge wall 14 are formed as shown in FIG. 7 by performing a press process for the metallic plate as described later while considering that the thickness of the edge wall 14 is not enough thick to mount the window glass 44 on the upper end of the edge wall 14. In this case, when the inner wall surface 11 is continuously pressed (blanked) and drawing-processed, the thickness of the inner wall surface 11 is reduced due to the malleability of the metallic plate and the thickness of the edge wall 14 is relatively increased. In addition, as shown in FIG. 8, the same inner wall surface 11 and the same edge wall 14 are formed using a larger metallic plate, and a portion extending from the edge wall 14 is bent inward to form a folding surface 15, thereby increasing the width of the upper end of the edge wall 14 to facilitate the forming of the step surface 17 and to increase the width of the step surface 17. Accordingly, the mounting of the window glass 40 can be easily and stably performed, so that the metallic case for the portable phone can be manufactured without clearance even due to the thermal deformation.

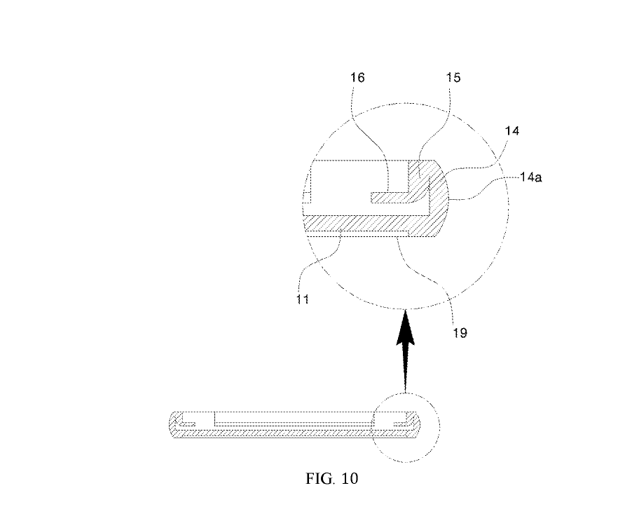

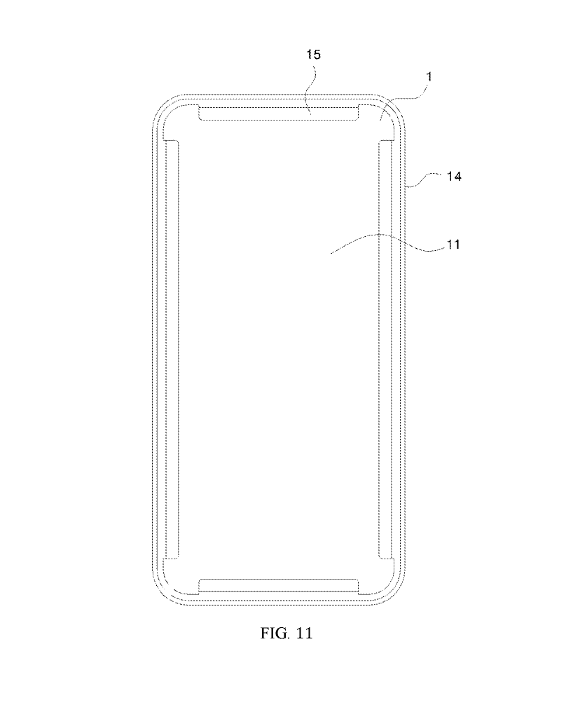

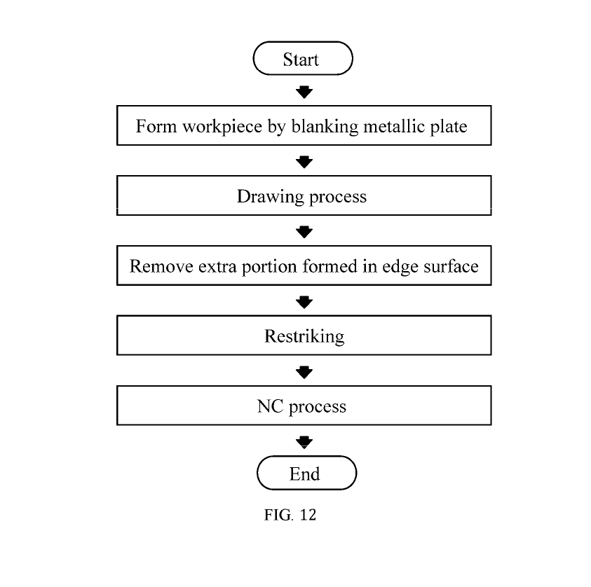

As shown in FIG. 10, after more extending the edge wall 14 upward, the edge wall 14 is bent inward to form the folding surface 15 folded in close contact with the edge wall 14, and a front end of the folding surface 15 is bent inward again to form a support place 16. Accordingly, the window glass 40 can be easily mounted on the support surface 16 without an NC process for the upper end of the edge wall 14.

In this case, as shown in FIG. 11, when the edge wall 14 is folded inward to form the folding surface 15 after the edge wall 14 has extended upward, a winkle may be formed on the folding surface 15 located at a corner portion 18. In consideration with this, the corner portion 18 is cut out to form a cut-out portion 1.

Hereinafter, a method of manufacturing the metallic case according to the first embodiment of the present invention will be described for the realization of the above configuration.

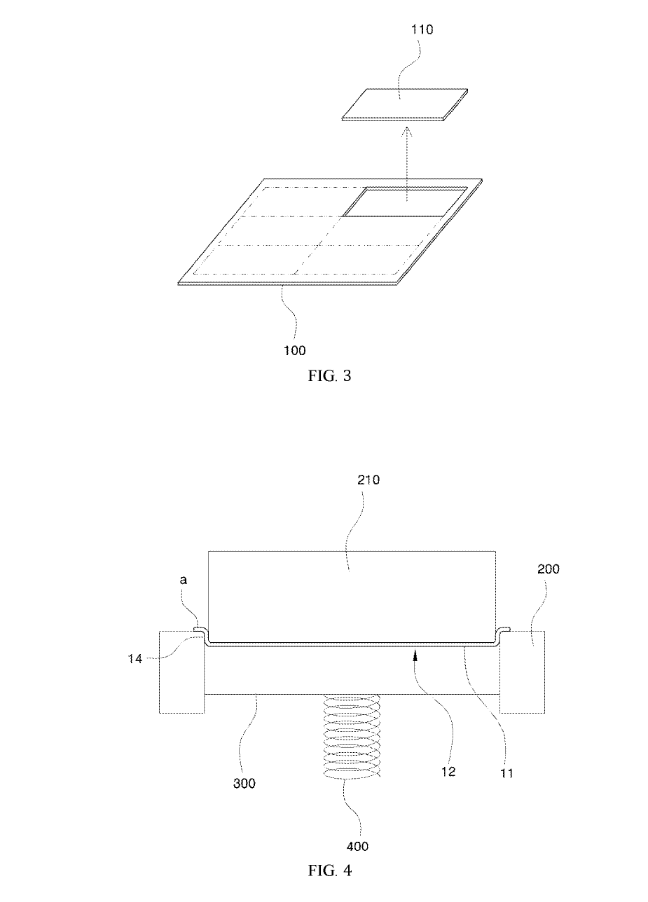

As shown in FIG. 3, for the press process, one metallic plate 100 is blanked so that a plurality of workpieces 110 are formed in required size, thereby performing a first step.

According to the present invention, the required size of the workpieces 110 means a development area when the inner wall surface 11 to be described below and the edge wall 14 formed by bending the edge of the inner wall 11 are developed, and is determined to prevent an unnecessary source material (workpiece) and thus save the source material, and to facilitate a drawing process.

Next, as shown in FIG. 4, after placing the workpiece 110 that is blanked in the first step on the die 200, a punch 210 presses and inserts a remaining portion of the workpiece 110 into the die 200 in the state the workpiece 110 is fixed to the edge of the die 200, or the workpiece 110 is pressed by a press to form a jointless rectangular frame 12 having the edge wall without defects such as wrinkles, or fractures, thereby performing a second step.

In other words, the inner space 13a having a predetermined area is provided in only one surface of the inner wall surface 11, so that the rectangular frame 12 including the edge wall 14 is formed.

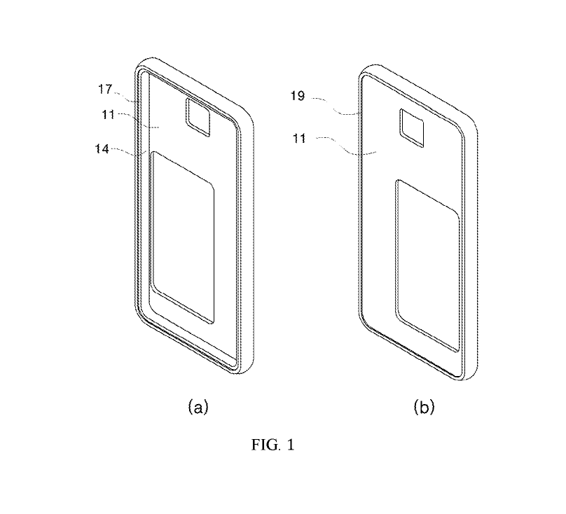

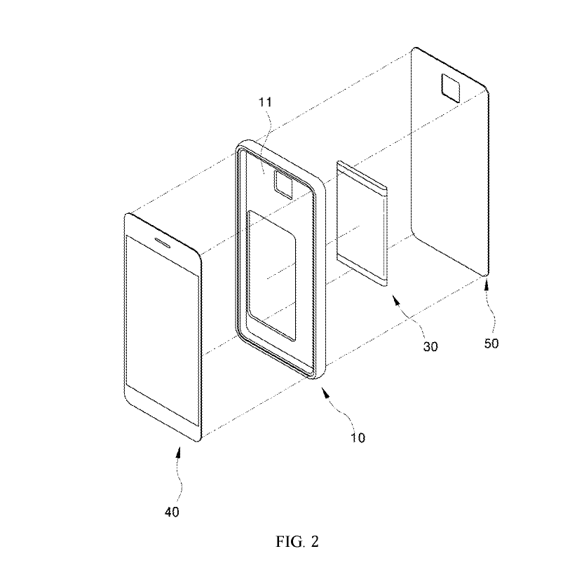

In this case, for the communication between the electronic components and the battery mounted in the inner space 13a, the inner wall surface 11 may be formed therein with a through hole if necessary as shown in FIGS. 1 and 2.

Subsequently, as shown in FIG. 5, to maintain the shape of the rectangular frame 12 having the inner space 13a and the edge wall 14 formed in the second step, an extra portion α, which does not form the edge wall 14 of the rectangular frame 12 and extends outward, is cut and removed, thereby performing a third step.

In this case, burrs formed when removing the extra portion α may be disposed through a post process such as a milling or grinding process, and the present invention is not limited thereto, but various manners, which are well known, may be used.

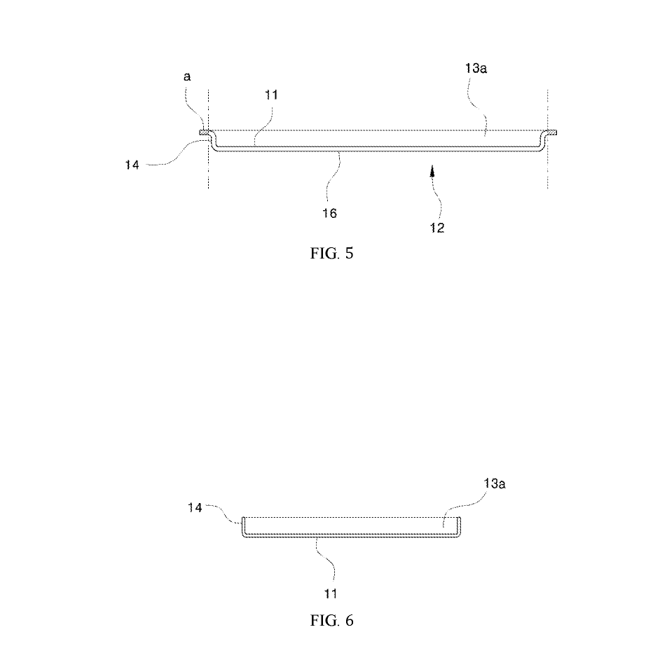

Next, as shown in FIG. 6, in the rectangular frame 12 having the edge wall 14 from which the extra portion α is removed in the third step, a portion, which is deformed after performing the drawing process in the second step in order to maintain the inner space 13a formed in the second step in predetermined size, is processed again, thereby performing the fourth step.

According to the present invention, a restriking process of the press process is used in the fourth step. However, as long as the object of the present invention is accomplished through another forming manner, various manners can be used. In addition, even when the third step and the fourth step are exchanged, the object of the present invention can be accomplished.

Thereafter, as shown in FIG. 7, to mount the window glass on the front surface of the rectangular frame 12 subject to the restriking process in the fifth step, and mount the cover on the rear surface of the rectangular frame 12 in the fifth step, the step surface 17 and the insertion groove 19 are realized through the NC process if necessary.

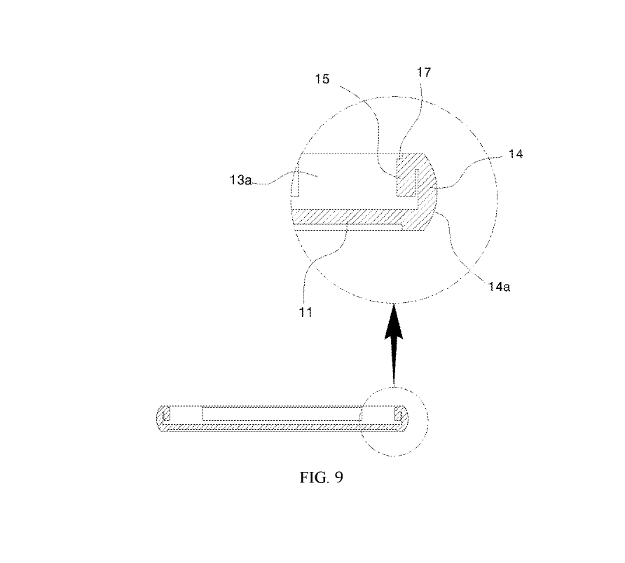

In this case, as shown in FIGS. 8 and 9, since the edge wall 14 has a limited thickness when the step surface 17 is formed to mount the window glass 40, after the edge wall extends upward, the upper end of the edge wall is folded inward to form a folding surface 15, so that the folding surface 15 makes close contact with the inner surface of the edge wall 14 or is spaced apart from the inner surface of the edge wall 14. Accordingly, the exposed outer surface 14a of the edge wall 14 may be processed to have a curved surface or a chamfered surface inclined at a predetermined angle, and the upper end of the edge wall 14 is ensured with a wide width, so that the width of the step surface 17 is stably ensured to provide an excellent mounting capability for the window glass 40.

In addition, as shown in FIG. 10, when the upper end of the edge wall 14 is formed with the wide thickness, the folding surface 15 formed by folding inward the edge wall 14, and the support surface 16 formed by extending the folding surface 15, the excellent mounting capability of the window glass can be obtained without forming the step surface.

In this case, as shown in FIG. 11, in order to overcome folding in the corner portion, in which the support surface is formed, the corner portion is cut out to form the cut-out portion 1. Accordingly, the folding surface 15 or the support surface 16, which is not folded in the corner portion, may be formed.

Therefore, the metallic case 10 for the portable phone according to to the present invention may minimize the source material to be wasted in the manufacturing process, save the cost due to the mass production and the reduction of the processes, and may be obtained through the press process to be maintained in an exact molding size. The jointless metallic rectangular frame 12 is formed, and the window glass 40 and the cover 50 are mounted on the step surface 17 and in the insertion groove 19 formed at the upper end of the edge wall constituting the rectangular frame 12 and in the rear surface of the rectangular frame, so that a product having no joint in an outer appearance can be provided.

In addition, although the metallic case according to the present invention is formed in the shape of a concave pattern having a predetermined depth through a punch and a die, the present invention is not limited thereto, but various forming manners may be employed.

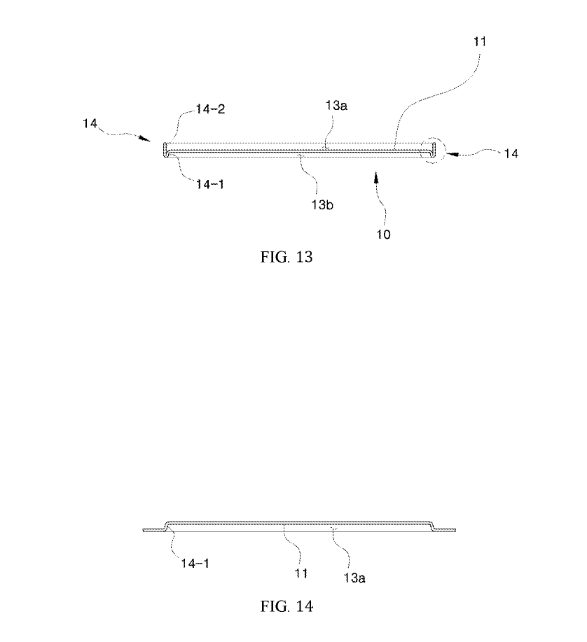

Next, as shown in FIG. 13, a metallic case 10 according to the second embodiment of the present invention applicable to the external battery type includes an inner wall surface 11 of a flat plate having a predetermined thickness and a predetermined area and edge walls 14 formed at the edges of the inner wall surface 11 perpendicularly to the inner wall surface 11 to form inner spaces 13a and 13b on which electronic components may be mounted at both sides of the inner wall surface 11.

In this case, to provide the inner spaces 13a and 13b in both surfaces of the inner wall surface 11 through the press process, the first edge wall 14-1 is formed by bending one lateral side of edges of the inner wall surface 11, and a second edge wall 14-2 is formed by bending and extending an upper end of the first edge wall in an opposite direction to that of the first edge wall and extending downward from the opposite surface of the inner wall surface.

Due to the overlap area between the first edge wall 14-1 extending to one surface of the inner wall surface and the second edge wall 14-2 extending to the opposite surface of the inner wall surface, even if strong external impact is applied to the edge wall, the buffering capability is increased to provide excellent impact resistance for the electronic components mounted on the inner wall surface 11.

In this case, the second edge wall 14-2 and the first edge wall 14-1, which are overlapped with each other, are spaced apart from each other, so that impact transfer hardly occurs due to the buffer even if the external impact is applied to the edge wall 14 of the metallic case including the first and second edge walls 14-1 and 14-2.

Hereinafter, a method of manufacturing the metallic case according to the second embodiment of the present invention will be described for the realization of the above configuration.

The first and second steps according to the second embodiment of the present invention are identical to those according to the first embodiment of the present invention.

Regarding the difference between the first embodiment and the second embodiment, as shown in FIG. 14, in the second step of the second embodiment, when the edge wall 14 is formed perpendicularly to the inner wall surface 11 through the drawing process, in the state that the first edge wall 14-1 is formed on the inner wall surface, the extra portion α of the flange extending outward perpendicularly to the first edge wall extends with a longer length in the second step without being removed in the second embodiment although the extra portion α of the flange is completely removed in the third step according to the first embodiment.

The third and fourth steps according to the second embodiment of the present invention are identical to the first embodiment.

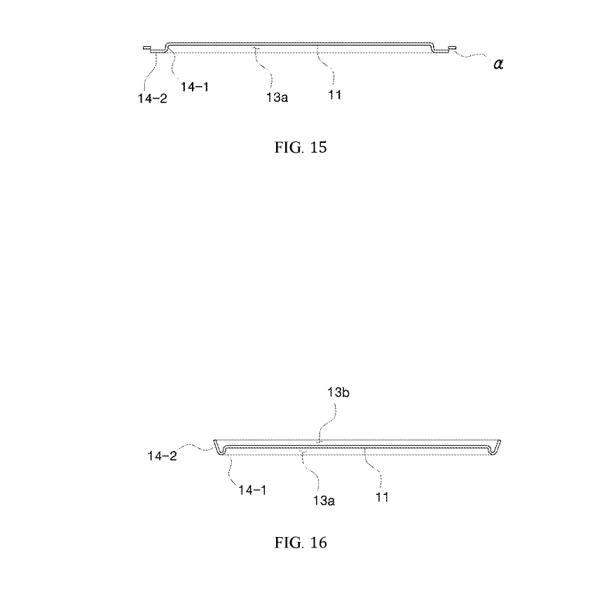

Regarding the difference between the first and second embodiments, as shown in FIG. 15, in the third step of the second embodiment of the present invention, the flange is not removed, but only a portion of the front end serving as an extra portion is removed.

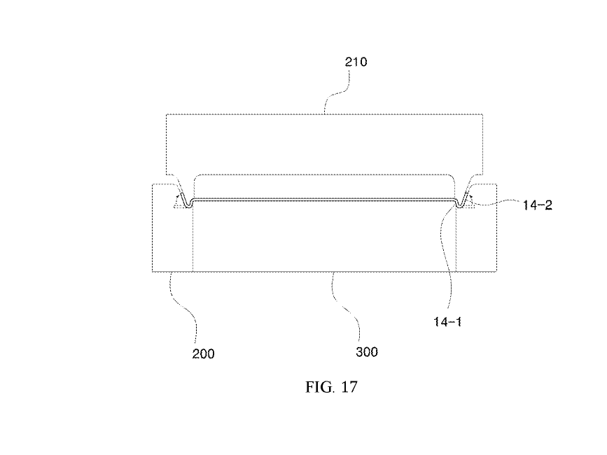

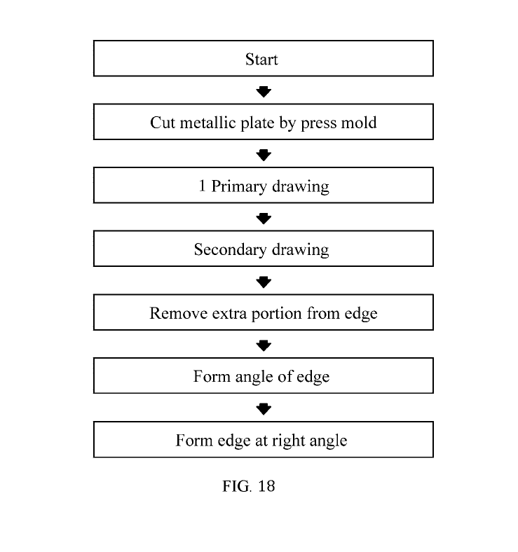

The fifth step according to the second embodiment of the present invention, is a step to primarily bend a portion of the metallic case for the second edge wall 14-2 at a predetermined angle in the state that only a portion of the front end of the flange serving as the extra portion α is removed in the fourth step as shown in FIGS. 16 and 17.

This step is a preliminary step to erect the first and second edge walls 14-1 and 14-2 in the state that the second edge wall 14-2 is formed corresponding to a finished product.

This step aims at a hemming process to allow the first and second edge walls 14-1 and 14-2 to make close contact with each other while bending the first and second edge walls substantially perpendicularly to the inner wall surface 11. Accordingly, in this step, the second edge wall 14-2 is processed by dividing an angle in two steps to three steps.

In other words, to form the first and second edge walls 14-1 and 14-2 overlapped with each other at the edges of the inner wall surface 11, the second edge wall 14-2 is folded by dividing the angle of a bending surface two times or three times so that the second edge wall 14-2 is folded with respect to the inner wall surface at 90° and the first edge wall at 180°.

The second edge wall is not folded at 180° one time because a necking section is formed at the front end (which is bent from the upper end of the first edge wall to form the second edge wall) where a workpiece extends, so that cracks may occur finally, and because a mold has a complex structure to make it difficult to completely fold the second edge wall once. Accordingly, the bending process is performed several times.

FIG. 17 is a view showing a bending process in a preliminary step according to one embodiment. To form the first and second edge walls 14-1 and 14-2 in a fifth step, the second edge wall 14-2 is bent using a punch, a die, and a pad in the state that the extra portion α of the front end of the flange is cut and removed in the third step.

The sixth step is a step to form the first and second edge walls 14-1 and 14-2 by increasing an angle of the second edge wall 14-2, which is bent on the edge of the inner wall surface 11 in the fifth step, to a right angle so that inner spaces 13a and 13b are formed in both surfaces of the inner wall surface 11 as shown in FIG. 13.

After the sixth step, the difference is made in height between the linear portion and the corner portion of the second edge wall 14-2 of the rectangular frame 12 constituting the metallic case 10 of a product after the extra portion α has been cut in the third step and the fifth step and the sixth step have been performed.

This reason is as follows. As the corner portion 18 of the metallic case 10 is finally left as the workpiece is compressed in the bending process, the metallic case 10 is formed with a higher height. The step difference is removed through a post process using milling or CNC high-speed machine while removing the burr formed in the third step to remove the extra portion α.

To allow the metallic case 10 of the product finished in such a manner, which is subject to the six steps, to have various shape, a chamfering process is performed with respect to the second edge wall 14-2, the step surface 17 is formed on the upper and lower ends of the second edge wall 14-2 to mount the window glass to display images thereon, or a tap process to fix a circuit board, a battery, or a camera module, a process to remove an unnecessary portion in order to reduce the weight of the product, and a process of forming a plurality of grooves to fix the product are performed similarly to the first embodiment of the present invention.

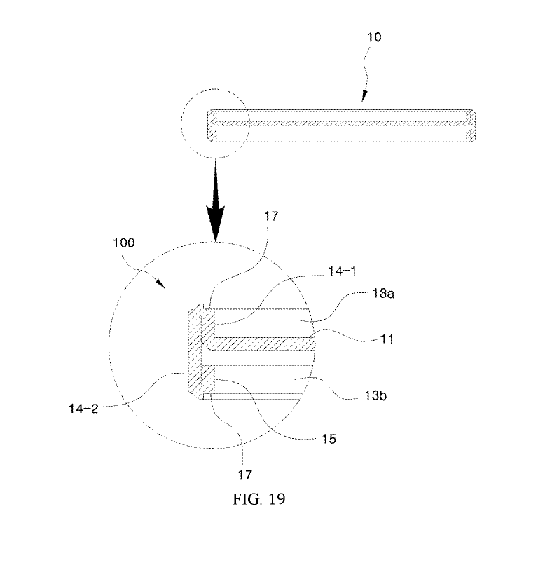

Hereinafter, a metallic case according to the third embodiment of the present invention applicable to an external battery type will be described. Regarding a basic structure, a first edge wall 14-1 is formed upward from the edge of the inner wall surface 11 to form a first inner space 13a by performing a drawing process with respect to a workpiece 110 obtained by performing a blanking process for a metallic plate having a predetermined thickness as shown in FIG. 19, a second edge wall 14-2 is formed by bending a flange, which extends outward at a right angle from the first edge wall 14-1, downward from the upper end of the first edge wall 14-1 to form the second inner space 13b, and a folding surface 15 is formed in the overlap with the inner portion of the second edge wall 14-2 by bending the front end of the second edge wall 14-2, which extends downward, again, so that the edge wall 14 of the rectangular frame 12 has a thickness thicker than that of the inner wall 11.

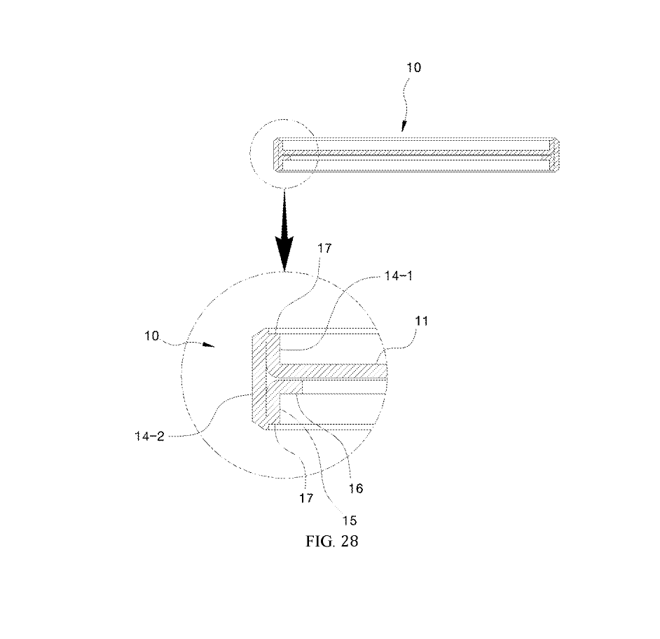

In addition, as shown in FIG. 28, a support surface 16 is formed horizontally to the inner wall surface 11 by bending the front end of the folding surface 15 again, so that excellent impact resistance is provided against external impact applied to the edge wall 14.

In addition, as shown in FIGS. 19 and 28, the forming of a step surface 17 for the mounting of the window glass or the battery cover to be mounted at the top and the bottom of the edge wall 14 which becomes thicker than the inner wall surface 11 as shown in FIGS. 19 and 28 can be easily performed.

In this case, although the step surface 17 according to the present invention is formed through an NC process, the present invention is not limited thereto.

In addition, similarly to the first and second embodiments of the present invention, the outer surface 14a of the edge wall 14 is processed to have a curved surface or an inclined surface inclined inward of both sides of the edge wall, thereby improving the grip feeling.

In order to realize the edge walls 14-1 and 14-2 according to the present invention, the workpiece 110 obtained by performing a blanking process with respect to one metallic plate having a uniform thickness is processed through press processes such as a drawing process, a hemming process, and a restriking process.

To this end, the present embodiment has the same steps as the first to fourth steps of the first and second embodiments of the present invention.

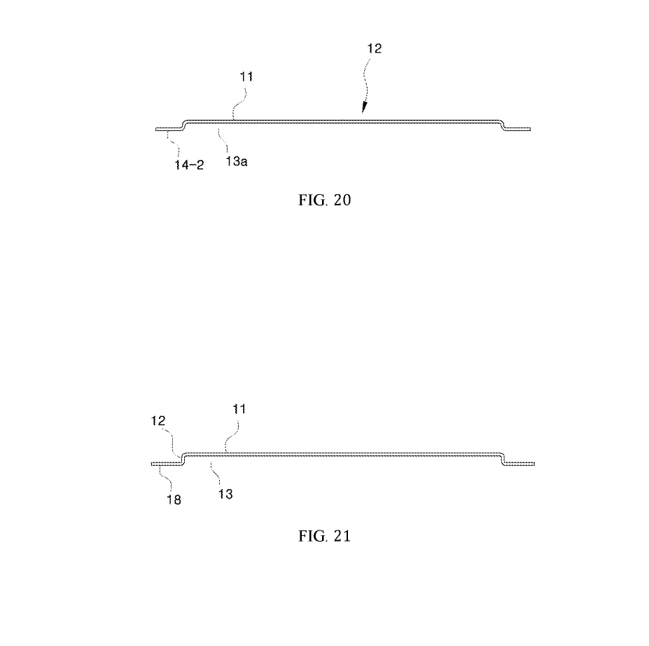

Regarding the difference, as shown in FIG. 20, according to the third embodiment, when a first edge wall 14-1 may be formed and a flange extending at a right angle to the first edge wally 14-1 may be formed in order to form inner spaces 13a and 13b having a predetermined depth at upper and lower portions of the inner wall surface 11 by forming first and second edge walls 14-1 and 14-2 on the edges of the inner wall surfaces 11 through a drawing process for the a workpiece 110 obtained by blanking a metallic plate having a uniform thickness in the second step, the flange may be formed with a length longer than that of the second embodiment of the present invention.

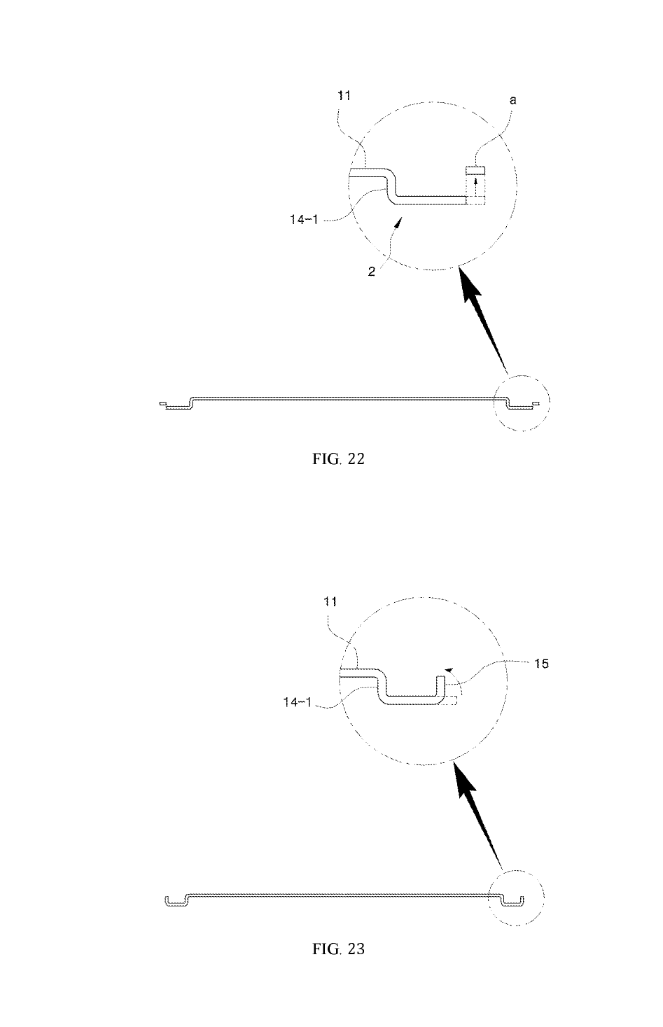

As shown in FIGS. 21 and 22, the processes in the fifth step include a restriking process of maintaining the inner space 13a in uniform size by the first edge wall 14-1 formed in the first to fourth steps, a trimming process of removing an extra portion α of the front end of the flange 2 extending outward of the first edge wall 14-1, and a process of forming the folding surface 15 by primarily bending a portion of the front end of the flange 2 at a right angle in the state that the extra portion α is removed and secondarily bending the portion of the front end at 180°.

Such processes are performed because the bending process for the folding surface 15 is difficult in the state that the second edge wall 14-2 is processed to be erected.

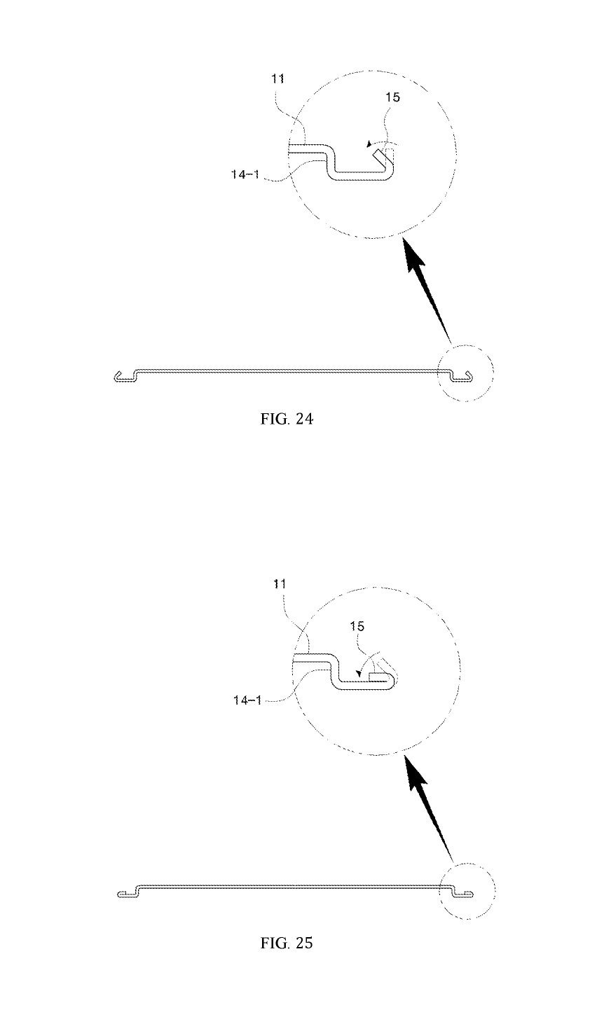

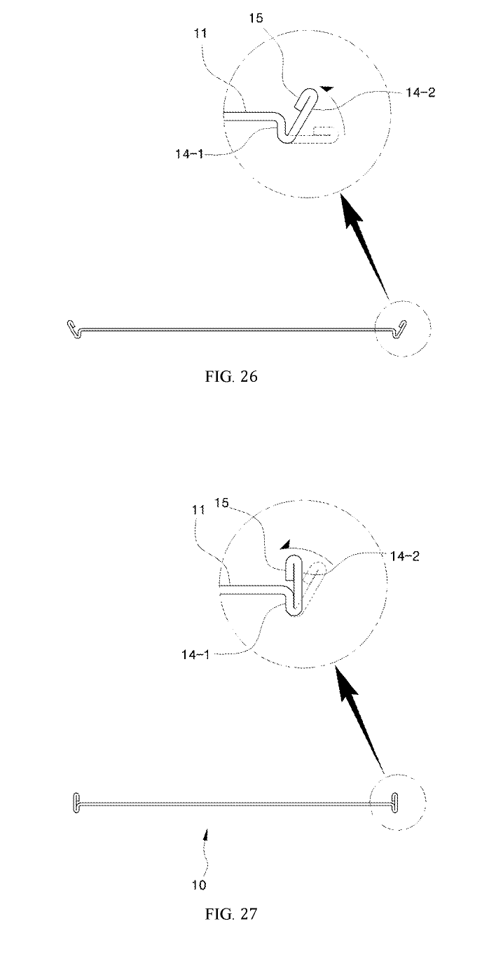

The sixth step shown in FIG. 24 is to bend the folding surface 15, which is bent upward at a right angle in the fifth step, at an inclination angle of 45° to facilitate the hemming process.

As described above, the second embodiment of the present invention includes the sixth step of performing a hemming process to allow the folding surface 15, which is bent at 45° to closely make contact with the second edge wall 14-2 when the folding surface 15 is bent at 180° with respect to the first edge wall 14-1 and processed in the state that the folding surface 15 is formed, the seventh step of bending the folding surface 15, which is hemmed in the sixth step, at 45°, and the eighth step of performing the hemming process with respect to the folding surface 15, which is bent at at 45° in the seventh step, to form the second edge wall 14-2.

Accordingly, when the edge wall 14 is formed on the edge of the inner wall surface 11, the edge wall 14 is doubly formed by the first edge wall 14-1, the second edge wall 14-2, and the folding surface 15, so that the thickness of the edge wall 14 is increased to provide excellent impact resistance. In addition, the buffer function is realized by the overlap structure, so that the excellent edge wall 14 is formed.

In addition, as the thickness of the edge wall 14 is increased, the step surface 17 is easily processed to mount the window glass or the battery cover.

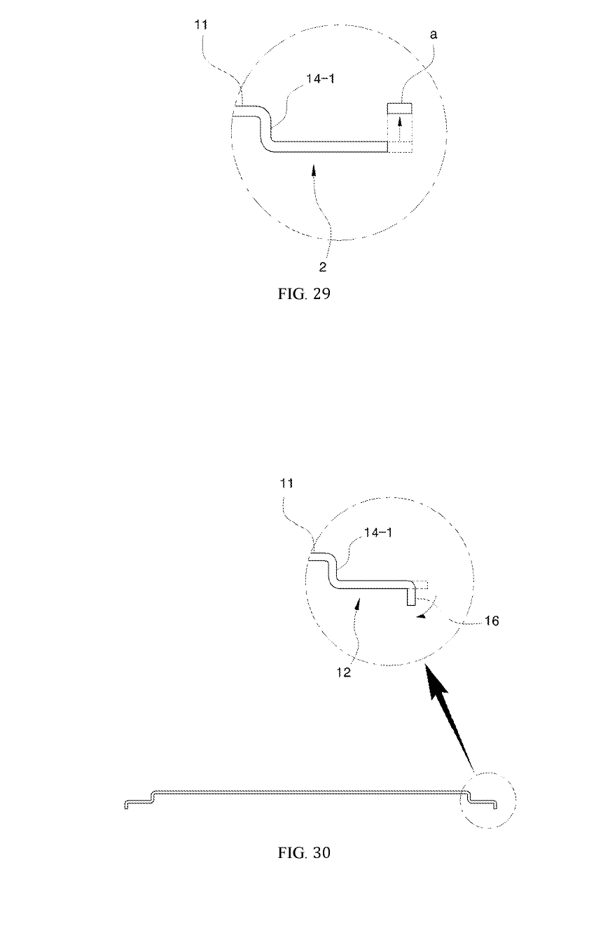

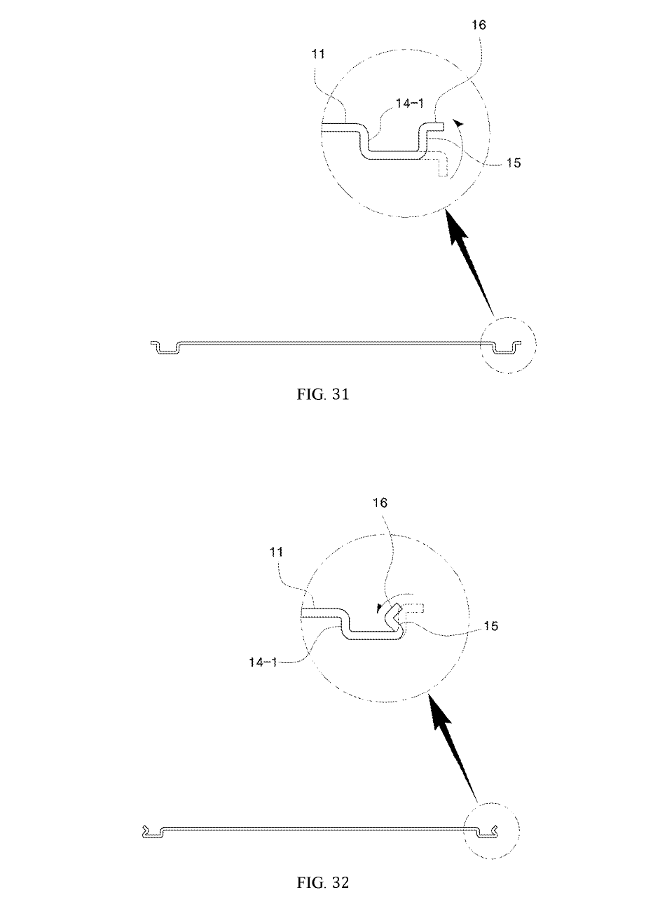

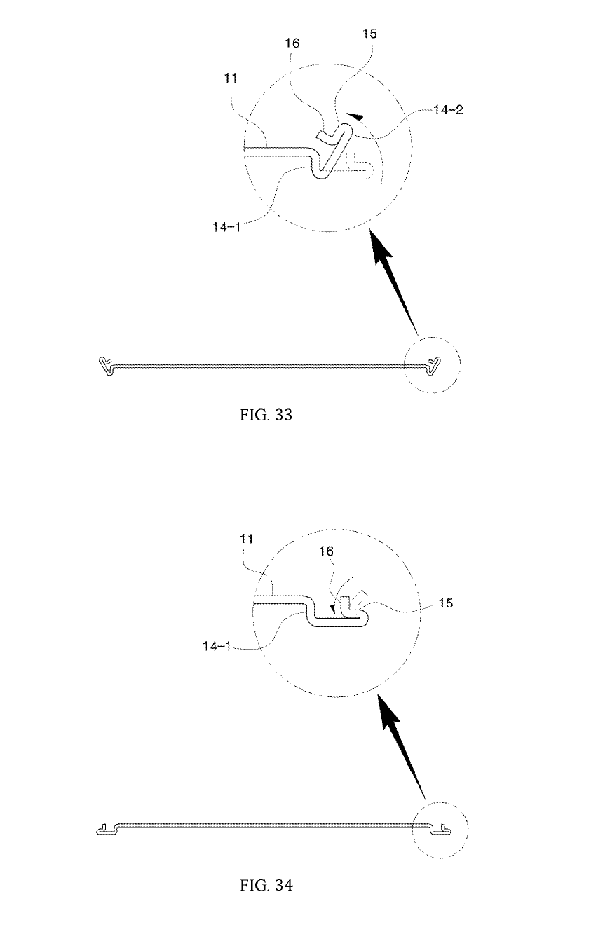

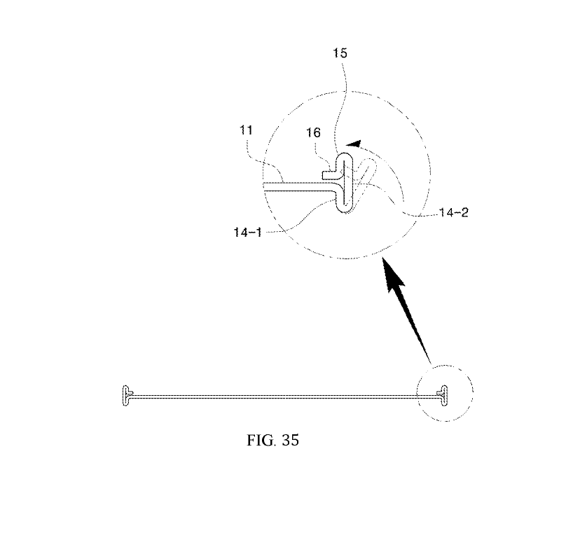

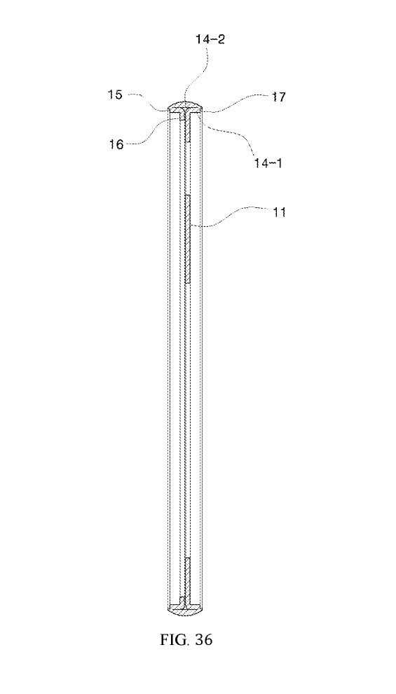

In addition, FIGS. 29 to 35 show another manufacturing process according to the third embodiment of the present invention. An intermediate process shown in FIG. 30 is additionally provided between the third step and the fourth step shown in FIG. 29 to bend the front end of the flange 2 downward at the right angle and perform the fourth and eight steps so that a support surface 16 may be formed using the front end of the folding surface 15.

Accordingly, the support surface 16 makes close contact with the inner wall surface 11, so that excellent bearing strength and excellent impact resistant are provided. In addition, when the outer surface 14a of the edge wall 14 is processed, countermeasures against external force are possible.

For reference, in order to form an inner space by forming the inner wall surface at the center of a flat metallic plate through a drawing process among press processes and forming the edge wall perpendicularly to the edge of the inner wall surface, a method of manufacturing and forming a jointless concave product in a required shape using the malleability of the workpiece includes a panel beating method to perform molding by striking a top of a support, a die drawing process using a die and a punch, and a spinning process to perform molding by pressing a board on a shelf using a mold.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A metallic case for a portable phone which is formed a press process, the metallic case comprising an inner space formed only in one side of an inner wall surface by forming an edge wall on an edge of the inner wall surface through a press process for one sheet of a metallic plate having toughness and malleability,
wherein the edge wall to form the inner space has a thickness thicker than a thickness of the inner wall surface through the press process, such that a step surface is easily formed at an upper end of the edge wall to mount a window glass.

2. The metallic case of claim 1, wherein, to form the edge wall having the thickness thicker than the thickness of the inner wall surface such that the step surface is formed at the upper end of the edge wall,
the edge wall extends upward, and then is folded inward to form a folding surface such that the folding surface makes close contact with an inner side of the edge wall or is spaced apart from the inner side of the edge wall, and
the step surface is easily formed at the upper end of the edge wall formed by the folding surface to mount the window glass.

3. The metallic case of claim 2, wherein a cut-out portion is formed in a corner portion having a support surface in a state that the support surface is formed inward of the inner space by bending the folding surface.

4. A method of manufacturing a metallic case for a portable phone through a press process, the method comprising:
forming a workpiece by blanking one metallic plate;
forming an edge wall as a punch presses and inserts the workpiece into a die, in a shape of a jointless rectangular frame having no defect including a wrinkle or a fracture;
cutting and removing an extra portion (α) of the edge wall formed in the shape of the rectangular frame; and
correcting a deformed portion by pushing and restriking the deformed portion to correctly form a shape or a dimension of a product formed in the thirdly cutting and removing of the extra portion (α) of the edge wall formed in the shape of the rectangular frame,
wherein a folding surface is formed to be overlapped with the edge wall in the shape of the rectangular frame after the restriking is performed, while making close contact with an inner surface of the edge wall or being spaced apart from each other, such that an exposed outer surface of the edge wall has a curved surface or a chamfered surface inclined at a predetermined angle, and a step surface is easily formed at an upper end of the edge wall to mount a window glass.

5. The method of claim 4, wherein the support surface is formed inward of an inner space by bending a front end of the folding surface again to facilitate mounting of the window glass without forming the step surface, and
a cut-out portion is formed in a corner portion of the support surface to remove a folding portion at the corner portion when the front end of the folding surface is bent to form the support surface.

6. A method of manufacturing a metallic case for a portable phone through a press process, the method comprising forming an edge wall to form inner spaces in both sides of an inner wall surface using one sheet of a metallic plate having malleability and toughness through the press process,
wherein a first edge wall is formed to be erected by bending an edge of the inner wall surface,
a second edge wall is formed to be bent downward from an upper end of the first edge wall,
an overlap surface is formed to be overlapped with the first edge wall as the second edge wall extends downward of the inner wall surface, and
a step surface is formed at the upper end of the first edge wall having the overlap surface to mount a window glass.

7. A method of manufacturing a metallic case for a portable phone through a press process, the method comprising:
cutting a metallic plate in a predetermined size to form a workpiece such that the metallic case is manufactured;
performing a primary drawing process to form a first edge wall at an outer portion of the workpiece while forming an inner space having a concave shape only at one surface of the workpiece;
performing a secondary drawing process with respect to the workpiece subject to the primary drawing process to form the first edge wall at the outer portion of the workpiece while forming the inner space only at the one surface of the workpiece;
cutting and removing an extra portion (α) of the workpiece except for a remaining portion for a second edge wall of the metallic case after performing the primary and secondary drawing processes;
performing a preliminarily bending process with respect to the workpiece at a primary bending angle to form the second edge wall of the metallic case after removing the extra portion (α); and
forming the second edge wall such that inner spaces are formed at both surfaces of the inner wall surface by erecting the second edge wall at a right angle in order to form the first and second edge walls at edges of the inner wall surface constituting the metallic case.

8. The method of claim 7, wherein the metallic material used in the cutting of the metallic plate represents an excellent elongation percentage and an excellent plastic workability, contributes to weight reduction, is economical in price of the workpiece to save cost, represents excellent thermal conductivity to be suitable for internal heat radiation of the portable phone, and is subject to a press process at a room temperature.

9. The method of claim 7, further comprising performing a drawing process again through a restriking process to stabilize the workpiece to a correct size since the workpiece in a concave shape is not formed in a required size due to elasticity of the workpiece when the workpiece is formed in the concave shape in the performing of the primary drawing process.

10. The method of claim 7, wherein a hemming process of folding the second edge wall at a right angle is performed by dividing an angle in two steps or three steps when the first and second edge walls are formed.

11. The method of claim 7, wherein a height difference between a linear portion of an upper end of the second edge wall and a corner portion of the second edge wall and a burr formed after cutting the extra portion (α) are removed through a post process using milling or CNC high-speed machine after the cutting of the extra portion (α) of the workpiece except for the remaining portion for the second edge wall, the performing of the preliminarily bending process and the forming of the second edge wall.

12. A metallic case for a portable phone which is formed through a press process, the metallic case comprising:
a first inner space formed by a first edge wall formed upward from an edge of an inner wall surface by performing a drawing process with respect to one side of one metallic plate having a predetermined thickness; and
a second inner space formed by a second edge wall formed by bending a flange, which is spread outward at a right angle from the first edge wall, downward from an upper end of the first edge wall,
wherein a folding surface extending upward is formed to be overlapped with an inner portion of the second edge wall by bending a front end of the second edge wall, which extends downward, upward, such that an edge wall of a rectangular frame has a thickness thicker than a thickness of the inner wall surface, and
step surfaces are formed to mount a window glass and a battery cover on and under the first and second edge walls having thicknesses thicker than the thickness of the inner wall surface to mount a window glass and a battery cover.

13. The metallic case of claim 12, wherein a front end of the folding surface is bent again to form a support surface to make close contact with the inner wall surface such that excellent impact resistance is represented against external impact applied to the edge wall.

14. A method of manufacturing a metallic case for a portable phone through a press process, the method comprising:
a first process of forming a first edge wall at an edge of an inner wall surface to form an inner space having a predetermined depth while forming a flange spread at a right angle by performing a drawing process with respect to one sheet of a metallic plate having a predetermined thickness;
a second process of performing a restriking process to maintain a size of the inner space uniformly by the first edge wall;
a third process of removing an extra portion (α) of the flange extending outward of the first edge wall through the restriking process;
a fourth process of forming an overlap surface by bending a front end of the flange upward at a right angle after removing the extra portion (α) of the flange;
a fifth process of bending the overlap surface, which is formed by bending the front end of the flange upward at a right angle, at an inclination angle of 45° to facilitate a hemming process;
a sixth process of performing the hemming process to bring the overlap surface bent at 45° into close contact with a second edge wall;
a seventh process of bending a part having the overlap surface, which is hemmed, at 45°; and
an eighth process of performing a hemming process with respect to the part bent at 45°.

15. The method of claim 14, further comprising bending the front end of the flange downward at a right angle between the third process and the fourth process, and performing fourth to eighth processes to form a support surface using a front end of a folding surface.
